(19) United States
(12) Patent Application Publication
(10) Pub. No.: US 2010/0175287 A1
(43) Pub. Date: Jul. 15, 2010

(54) VIDEO GREETING CARD

(75) Inventors: Shekhar Gupta, Overland Park, KS (US); Carl M. Coppage, Kansas City, MO (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/352,821

(22) Filed: Jan. 13, 2009

(51) Int. Cl. G09F 1/00; H04W 4/12

(52) U.S. Cl. 40/124.01; 455/466

(57) ABSTRACT

A greeting card may include a paper card featuring an expression, an input/output (I/O) unit, a memory, and a processor connected to the paper card and in communication with the I/O unit and memory. The processing unit may be configured to receive video content via the I/O unit, store the video content in the memory, and transmit video content via the I/O unit, thereby enabling a recipient of the paper card to view the video content. The greeting card may enable a sender of the video greeting card to download video content into the memory device on the video greeting card, and enable a recipient of the greeting card to upload the video content for display on an electronic display for the recipient to watch. The electronic display may be on a mobile telephone to which the greeting card communicates the video content.

### BACKGROUND

Greeting cards have long been a tradition for people to express themselves to others. Greeting cards are used to wish someone sentiments on special occasions, such as birthdays, anniversaries, sympathies, holidays, sickness, graduations, and other special occasions. Greeting cards come in all shapes and sizes. While communications technologies, such as mobile telephones, e-mail, and other forms of communications, have advanced, traditional greeting cards remain in strong demand.

### SUMMARY

To advance greeting cards to catch up with current communications technology, the principles of the present invention provide for a greeting card to include electronic devices that enable a sender to download video content to the greeting card so that a recipient can view the video content. In one embodiment, a sender of the greeting card may download a video using a wire or wireless connection to store the video content on the electronic devices. The wireless connection may be a Bluetooth® connection. The recipient may view the video content by uploading the video content to a computer, mobile telephone, smart phone or other fixed or mobile electronic device. In one embodiment, the video content may be uploaded via a wireless connection, such as a Bluetooth® connection.

One embodiment of a greeting card may include a paper card featuring an expression, an input/output (I/O) unit, a memory, and a processor connected to the paper card and in communication with the I/O unit and memory. The processing unit may be configured to receive video content via the I/O unit, store the video content in the memory, and transmit video content via the I/O unit, thereby enabling a recipient of the paper card to view the video content.

One embodiment of a method for manufacturing a greeting card may include providing a paper card featuring an expression, an I/O unit, and a memory. A processor may be connected to the paper card. The processor may be in communication with the I/O unit and memory, and configured to receive video content via the I/O unit, store the video content in the memory, and transmit video content via the I/O unit to a remotely located device.

One embodiment of a method for operating a video greeting card may include enabling a sender of the video greeting card to download video content into a memory device on the video greeting card, and enabling a recipient of the greeting card to upload the video content for display on an electronic display for the recipient to watch.

### BRIEF DESCRIPTION

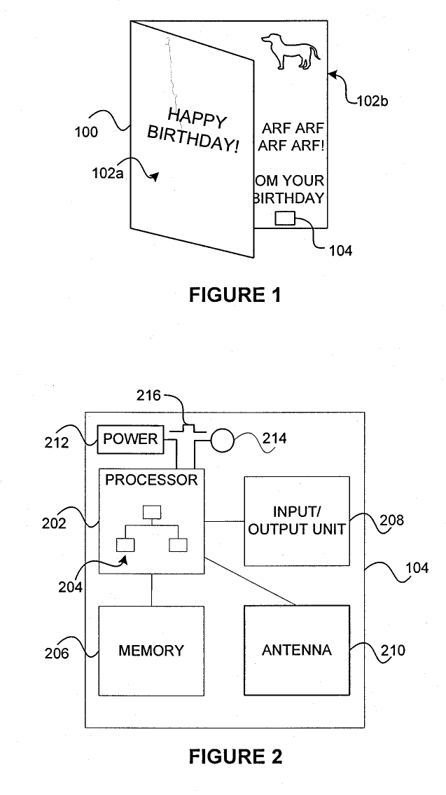

FIG. 1 is an illustration of an illustrative video greeting card;

FIG. 2 is a block diagram of an illustrative processing unit configured to receive, store, and transmit video content;

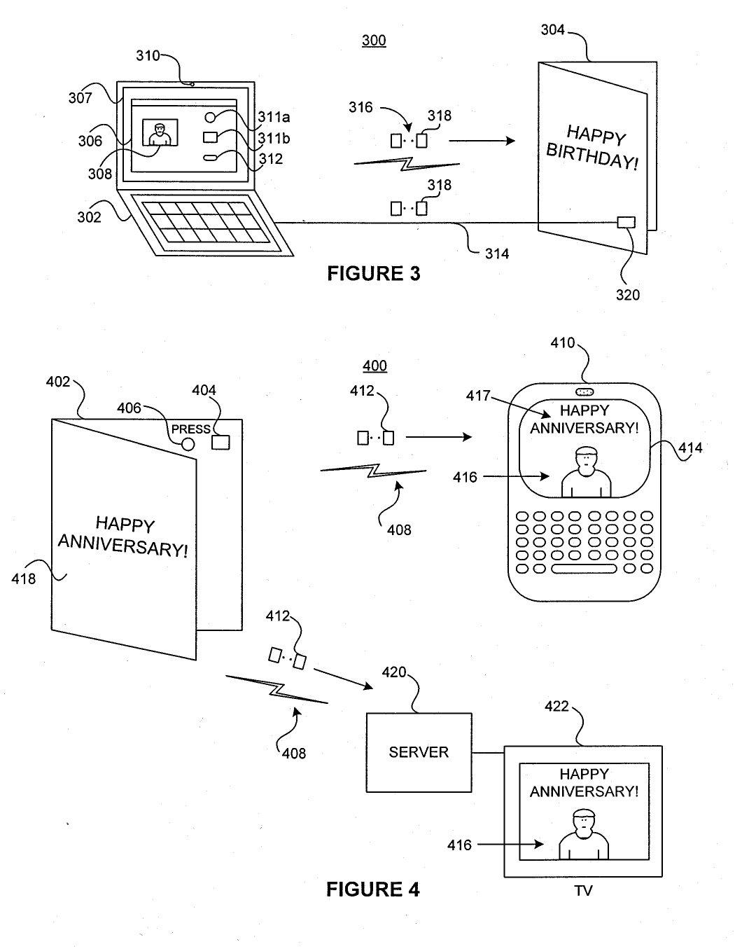

FIG. 3 is an illustrative environment in which video content is downloaded to a video greeting card;

FIG. 4 is an illustrative environment in which video content stored on a video greeting card is communicated to an external electronic device for display of the video content;

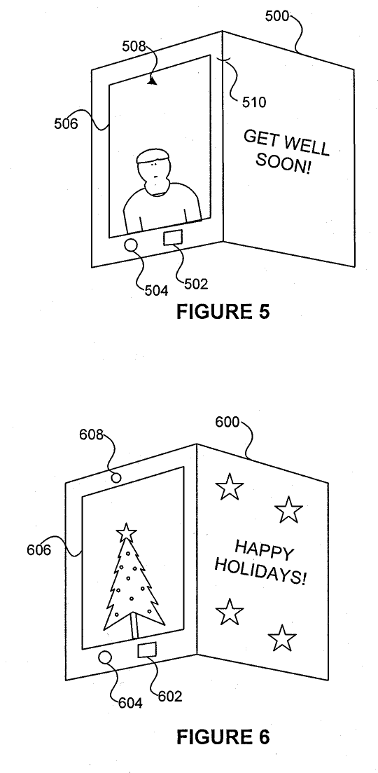

FIG. 5 is an illustrative video greeting card including an electronic display;

FIG. 6 is an illustration of an illustrative greeting card including a video camera for capturing video content;

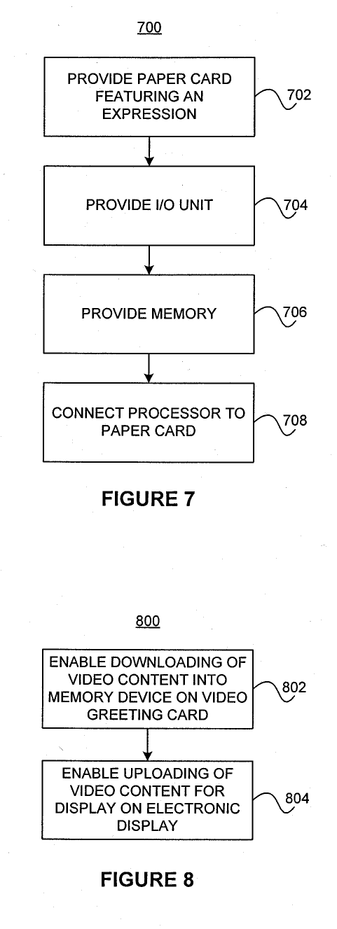

FIG. 7 is a flowchart of an illustrative process for manufacturing a video greeting card in accordance with the principles of the present invention; and

FIG. 8 is a flowchart of an illustrative process for operating a video greeting card.

### DETAILED DESCRIPTION

With regard to FIG. 1, an illustrative video greeting card 100 is shown to include a paper card 101 having printed thereon expressions 102a and 102b (collectively 102) that are representative of a special occasion (e.g., birthday wishes) or other sentiment. As understood in the art of greeting cards, the paper card 101 is typically folded to “invite” a recipient to open the paper card 101 to view the expression 102b printed on the inside of the paper card 101. The expressions 102 may be representative of any occasion, including anniversary, graduation, sympathies, illness, and any other occasion that one may wish to send a recipient. The expressions 102 may be text, illustrations, photographs, or any other graphic that conveys a special occasion.

In accordance with the principles of the present invention, a processing unit 104 may be attached to the paper card 101. In attaching the processing unit 104 to the paper card 101, glue or any other adhesive may be utilized, as understood in the art. Alternatively, the processing unit 104 may be connected to the paper of the video greeting card using a connection mechanism, such as a snap, tack, or any other fastener as understood in the art. In being “connected” to the paper card 101 of the video greeting card 100, the processing unit 104 may be fixedly or otherwise attached to the paper so as to not fall off during shipping or use by a recipient of the video greeting card 100. In one embodiment, the processing unit 104 may be inserted into a slot or sandwiched between multiple sheets of paper that are used to form the video greeting card 100. Still yet, a socket may be connected to the paper card 101 and a chip, which may be purchased separately, may be loaded with a video by a sender of the greeting card and connected to the socket prior to sending to a recipient.

With regard to FIG. 2, the processing unit 104 of FIG. 1 may include a processor 202 that executes software 204. The processor 202 may be in communication with a memory 206, input/output (I/O) unit 208, and antenna 210. The processor 202, memory 206, and I/O unit 208 may be integrated into a single chip. In one embodiment, the antenna 210 may be integrated into the I/O unit 208. Alternatively, the antenna 210 may extend from the I/O unit 208 and be positioned within the video greeting card such that the antenna 210 is not viewable by a buyer or recipient.

The processor 202 may execute the software 204 that operates to enable a sender of a video greeting card to download video content that the processor 202 receives and stores in the memory 206. The video content may be compressed video, such as an MPEG format. It should be understood that the software 204 may additionally be configured to store a photograph. The processor 202 may be configured to communicate with the I/O unit 208 to communicate the video content stored in the memory 206 so that a recipient of the video greeting card may upload the video content and display the video content on an electronic display. In one embodiment, the processor 202 may be configured to communicate the video content utilizing a wireless communications protocol, such as Bluetooth® communications protocol. Using the wireless communications protocol, the video content may be communicated to a locally remote electronic device. The locally remote device may be a computer, mobile telephone, smart telephone, personal digital assistant (PDA), or any other wireless device capable of receiving video content via the wireless communications protocol. In one embodiment, the mobile telephone or other mobile device may include a projector to project the video content onto a surface to give the video a hologram type effect, such as one described in U.S. patent application Ser. No. 12/180,874 filed on Jul. 28, 2008, which is herein incorporated by reference in its entirety.

A power source 212, such as a battery or any other charged storage device, may be included with the processing unit 104 to enable operation of the processor 202, memory 206, and I/O unit 208. A push-button 214 or any other device may be configured to generate a signal 216 that causes the processor 202 to initiate communication of video content stored in the memory 206 to be communicated via the I/O unit 208 and antenna 210. In an alternative embodiment, a physical connection may enable a user to download and upload video content via a wire or cable as opposed to a wireless connection.

With regard to FIG. 3, an illustrative environment 300 may include a computing device 302 and video greeting card 304. The computing device 302 may show a graphical user interface (GUI) 306 on an electronic display 307 that shows video content 308 captured by a video camera 310 incorporated into or external from the computing device 302. The video content 308 may be a greeting that is created by a sender or other user of the video greeting card 304 for a recipient of the video greeting card 304 to view. A start soft-button 311a may be selected by a sender to initiate recording of the video content 308, and stop soft-button 311b may be selected by the sender to stop recording the video content 308. In one embodiment, the sender may also enter a mobile telephone number of the recipient.

Once the sender is satisfied with the video content that has been recorded, the sender may select a soft-button 312 to initiate downloading of the video content 308 to the video greeting card 304. If the sender entered a telephone number of the recipient, then the telephone number is downloaded to the video greeting card. In one embodiment, a cable 314 may be configured to connect the computing device 302 to the video greeting card 304 to enable the video content 308 in the form of data packets 318 to be downloaded to a processing unit 320 for storage in a memory device. An alternative embodiment, an air interface 316 may be utilized to communicate data packets 318 of the video content 308 for receipt and storage by the processing unit 320 on the video greeting card 304. The air interface 316 may utilize Bluetooth® communications protocol for communicating the video content to the video greeting card 304. It should be understood that any other communications protocol, such as infrared, WiFi, and WiMAX, may be utilized in accordance with the principles of the present invention.

The GUI 306 may be a website located on a network, such as the Internet. The website may be provided by a greeting card company, communications company, or co-developed by both to enable purchases of video greeting cards to record, store, and download video or photograph content to video greeting cards. In an alternative embodiment, software may be downloaded to the computing device 302 for a user to generate the video content. If a telephone number of the recipient mobile telephone is entered, the website may access information of the mobile telephone, such as a mobile station identifier (MSID), for the processing unit 320 to identify the mobile telephone when in communication range of the mobile telephone. An upload signal may be generated in response to determining that the mobile telephone is within range of the video greeting card 304. Although the computing device 302 is shown as a laptop computer, it should be understood that the computing device 302 may alternatively be a mobile telephone, smart telephone, or any other electronic device that is capable of recording video content and communicating the video content to a video greeting card.

With regard to FIG. 4, an illustrative environment 400 is shown to enable a recipient of a video greeting card 402 to access video content stored in a processing unit 404 that is connected to the video greeting card 402. In this embodiment, the video greeting card 402 is provided with the push-button 406 that enables a user to press the push-button 406 to activate the processing unit 404 to access and communicate the video content over a wireless communications path 408 to a wireless device 410. In one embodiment, the wireless device 410 is a BlackBerry® wireless device. The wireless device 410 may have a software application or applet (not shown) that is downloaded for receiving and displaying the video content from the video greeting card 402.

In one embodiment, the software application detects communications from the video greeting card 402 and automatically opens for display of the video content. Alternatively, the software application may generate a request signal that, when received by the processing unit 404, causes the processing unit 404 to communicate the video content to the wireless device 410. Still yet, if the telephone number of the recipient was included with the video content, rather than the recipient having to press the push-button 406, the processing unit 404 may automatically determine if the video greeting card 402 is in range of the mobile telephone and, in response to determining that the mobile telephone is within range, connect with the mobile telephone and upload the video content.

One embodiment of the video greeting card 402 may be configured to disable a security feature of the wireless communications protocol (e.g., Bluetooth® communications protocol) on the wireless device 410 by an application being executed on the wireless device 410 so as to enable the video content to be uploaded without user intervention. As currently understood, if a user pairs a Bluetooth® enabled device with a mobile telephone, the user typically enters ‘0000’ as a security code. By the application automatically disabling the security feature in response to receiving an upload request from the video greeting card, the video content may be uploaded without user intervention.

In operation, disabling the security feature of the wireless device 410 may be performed by the processing unit 404 sending a card connect signal (not shown) to the wireless device 410. The wireless device 410 may acknowledge receipt of the card connect signal with an acknowledgement signal (not shown). The processing unit 404, in response, may access a security code (e.g., ‘0000’) stored in a memory and send the security code to the wireless device 410. In response to the wireless device 410 accepting the security code, the security feature may be disabled. A software application executing on the wireless device 410 may be initiated to synchronize with the processing unit 404, and receive and display the video content.

Data packets 412 may be utilized to communicate the video content to the wireless device 410 for display on an electronic display 414. As shown, video content 416 shows an image of a purchaser of the video greeting card 402 providing a video message to a recipient of the video greeting card 402. A title 417, “Happy Anniversary!” is provided, where the processing unit 404 may automatically generate the title 417. Alternatively, software that is used to record a video to generate the video content may be used to generate the title 417. It should be understood that the title 417 may match an expression 418 that is provided on the video greeting card 402. Still yet, no title may be generated for the video content 416.

As an alternative to communicating the video content to a mobile device 410, the video content may be communicated in the data packets 412 to a transceiver 420 that is connected to a television 422. The transceiver 420 is configured with electronics to enable wireless or wired communications with the video greeting card 402.

With regard to FIG. 5, an illustrative video greeting card 500 is shown to include a processing unit 502 and push-button 504. In addition, the video greeting card 500 may include an electronic display 506 that is thin enough to be included on paper of the video greeting card. In one embodiment, the electronic display 506 is electronic ink or e-ink, as understood in the art. Video content 508 is displayed on the electronic display 506 by the processing unit 502 in response to a user pressing the push-button 504 or receiving a signal from a sensor 510 that senses when the video greeting card 500 is opened by a recipient. The sensor 510 may be electromechanical or an electronic sensor, such as a light sensor.

With regard to FIG. 6, an illustrative video greeting card 600 is shown to include a processing unit 602, push-button 604, and electronic display 606. In addition, a video camera 608 is connected to the video greeting card 600 that enables a purchaser of the video greeting card 600 to record video content without having to access an external video recorder. Software (not shown) that is executed by the processing unit enables the user to record the video content using the video camera 608 for storage on a memory (not shown) on the processing unit 602 and display of recorded video content on the electronic display 606.

With regard to FIG. 7, an illustrative manufacturing process 700 for manufacturing a video card is provided. At step 702, a paper card featuring an expression is provided. At step 704, an I/O unit is provided. At step 706, a memory is provided. At step 708, a processor is connected to the paper card. The processor may be part of a processing unit that includes the I/O unit and memory. Alternatively, the I/O unit and memory may be connected to the paper card in the same or similar manner as the processor. It should be understood that the processor may be connected to the paper card in many ways, including but not limited to, not being directly connected to the paper card, but rather being connected to the paper card through another means. For example, the processor may be mounted to a printed circuit board that is connected or otherwise coupled to the paper card. Once the processor is connected to the paper card, the paper card and processor combined form a video greeting card that may be sold at retail stores or other locations.

The I/O unit may be configured to enable wireless communications of video content. In addition, a push-button or other mechanism may be connected to the paper card, where the processor is configured to receive a signal from the push-button to initiate uploading of video content to another electronic device for display of the video content thereon. In addition, a charge element, such as a battery, may be used to power electronics of the video card, including the I/O unit, memory, and processor. In one embodiment, an electronic display may be connected to the paper card for display of video content by the processor in response to a recipient opening the paper card or pressing a push-button or other mechanism to initiate playing of the video content.

With regard to FIG. 8, an illustrative process 800 for operating a video greeting card is provided. At step 802, downloading of video content into a memory device on the video greeting card may be enabled. In enabling the downloading of video content into the memory device, a wireless or wired connection may be provided to a user for recording video content on another electronic device and downloading the video content onto the video greeting card for storage thereon. Alternatively, the video greeting card may be provided with a video camera that enables a user to download video content by simply recording the video content using the video camera on the video greeting card.

At step 804, uploading of the video content for display on electronic display is enabled. In enabling the video content to be uploaded, a wireless or wired connection may be made by the video greeting card to another electronic device for upload and display of the video content thereon. In one embodiment, uploading of the video content may be initiated by a recipient of the video greeting card selecting a push-button or other mechanism that is within range of the other electronic device, such as a mobile telephone, and is configured with a wireless or wired communications interface that enables the video content to be communicated from the video greeting card to the electronic device.

1. A greeting card, comprising:
a paper card featuring an expression;
an input/output (I/O) unit;
a memory; and
a processor connected to said paper card and in communication with said I/O unit and memory, said processing unit configured to:
receive video content via said I/O unit;
store the video content in said memory; and
transmit video content via said I/O unit, thereby enabling a recipient of the paper card to view the video content.

2. The greeting card according to claim 1, wherein said I/O unit includes a wireless communications device.

3. The greeting card according to claim 2, wherein the wireless communications device is configured to transceive using Bluetooth® communications protocol.

4. The greeting card according to claim 1, wherein said processing unit is further configured to, in response to receiving a request, cause the video content to be communicated via said I/O unit remotely located from said paper card.

5. The greeting card according to claim 4, further comprising a push-button that, when activated, generates the request that causes said processing unit to initiate communication of the video content.

6. The greeting card according to claim 4, wherein the request is received from a locally remote device.

7. The greeting card according to claim 1, further comprising an electronic display in communication with said processor and configured to display the video content.

8. The greeting card according to claim 1, further comprising a video capture device in communication with said processor, and configured to capture digital images for storage by said processor in said memory.

9. The greeting card according to claim 1, wherein said processor is further configured to:
store a telephone number of a mobile telephone of the recipient; and
determine whether the mobile telephone of the recipient is within communication range; and
in response to determining that the mobile telephone of the recipient is within communication range, communicate the video content to the mobile telephone.

10. The greeting card according to claim 1, further comprising a battery configured to power said I/O unit, memory, and processor.

11. A method for manufacturing a greeting card, said method comprising:
providing a paper card featuring an expression;
providing an I/O unit;
providing a memory; and
connecting a processor to the paper card, the processor being in communication with the I/O unit and memory, and configured to receive video content via the I/O unit, store the video content in the memory, and transmit video content via the I/O unit to a remotely located device.

12. The method according to claim 11, wherein providing an I/O unit includes providing an I/O unit configured to wirelessly communicate the video content.

13. The method according to claim 11, further comprising connecting a push-button that, when activated, causes the processing unit to initiate communication of the video content.

14. The method according to claim 11, further comprising:
storing a telephone number of a mobile telephone of a recipient;
determining whether the mobile telephone is within communication range; and
communicating the video content to the mobile telephone in response to determining that the mobile telephone is within communication range.

15. The method according to claim 11, further comprising connecting an electronic display to the paper card configured to display the video content.

16. A method for operating a video greeting card, said method comprising:
enabling a sender of the video greeting card to download video content into a memory device on the video greeting card; and
enabling a recipient of the greeting card to upload the video content for display on an electronic display for the recipient to watch.

17. The method according to claim 16, wherein enabling the recipient to upload the video content includes wirelessly communicating the video content to a mobile device for display thereon.

18. The method according to claim 17, wherein enabling the recipient of the video greeting card to upload the video content includes, in response to receiving an initiate upload signal, causing the video content to be communicated from the video greeting card to the mobile device.

19. The method according to claim 17, wherein Tirelessly communicating the video content includes using Bluetooth® communications protocol.

20. The method according to claim 16, wherein enabling the recipient to upload the video content includes disabling a security feature on an electronic device for receiving wireless communications.
